(19) United States
(12) Patent Application Publication
(10) Pub. No.: US 2023/0407094 A1
(43) Pub. Date: Dec. 21, 2023

(54) ASPHALT ADDITIVES WITH MULTIPLE AMINES

(71) Applicant: Ascend Performance Materials Operations LLC, Houston, TX (US)

(72) Inventors: Zheng Chai, Houston, TX (US); Eric Geiger, Houston, TX (US); Chinenyeze Nwankwoala, Houston, TX (US); Karana Shah, Houston, TX (US)

(73) Assignee: Ascend Performance Materials Operations LLC, Houston, TX (US)

(21) Appl. No.: 18/337,726

(22) Filed: Jun. 20, 2023

Related U.S. Application Data
(60) Provisional application No. 63/353,899, filed on Jun. 21, 2022.

(51) Int. Cl. C08L 95/00; C08K 5/17; C08K 5/10; C08K 5/05; C08K 5/315

(52) U.S. Cl. CPC C08L 95/00; C08K 5/17; C08K 5/10; C08K 5/05; C08K 5/315; C08L 2555/10; C08L 2555/64

(57) ABSTRACT

An antistripping composition, comprising a first triamine compound or a second amine compound, and less than 1 wt % of a nitrile compound. When the antistripping composition is used in a bitumen composition, the bitumen composition demonstrates 50% or more retained coating as measured according to AASHTO T 283 (2022), and a tensile strength ratio of at least 80% when measured according to ASTM D 3625 (2020).

### PRIORITY CLAIM

This application claims priority to U.S. Provisional Application No. 63/353,899, filed Jun. 21, 2022, which is incorporated herein by reference.

### FIELD

The present disclosure relates generally to additives for bitumen compositions, such as asphalt compositions, e.g., asphalt concrete. In particular, the present disclosure relates to antistripping compositions, which may be used as additives for bitumen compositions. The present disclosure also relates generally to bitumen compositions having an antistripping additive added thereto.

### BACKGROUND

Bituminous aggregate mixtures are commonly used for paving materials and other construction material. For example, these mixtures are typically used to pave roadways, driveways, parking lots, and the like. Typically, the bituminous aggregate mixture comprises a mixture of aggregate materials, stones, gravel, sand or other mineral aggregates, bound by a bituminous binder, such as asphalt. The mixing of the aggregate material with the bituminous binder is accomplished in any of several known methods. For some mixtures, referred to in the art as hot-mix asphalt concrete (HMA), the aggregate material is heated at an elevated temperature from about 130° C. to 190° C. and mixed with the bituminous binder. The bituminous aggregate mixture is then applied to a surface and compacted at an elevated temperature. For other mixtures, referred to in the art as warm-mix asphalt concrete (WMA), the bituminous binder is mixed with an additional “soft” component, such as a zeolite or wax, which is melted and mixed with aggregate at a temperature ranging from 40° C. to 125° C. For still other mixtures, referred to in the art as cold-mix asphalt concrete, a cold aggregate material is mixed with a hot or cold binder, which may be an emulsion of asphalt in water, e.g., using a suitable surfactant, or a mixture of asphalt and a suitable hydrocarbon solvent. The emulsified asphalt particles coat and bind with the aggregate and remain after the water has evaporated.

Across all types bituminous aggregate mixtures, failure of the bituminous binder to adhere to the aggregate may result in separation, or “stripping,” of the binder from the aggregate. Typically, stripping is the result of water disrupting the bond between the bituminous binder and aggregate mixture and replacing the bituminous binder as the coating surrounding the aggregate. Stripping is often promoted by inclement weather and/or exposure of the compacted bituminous aggregate mixture to water. During the winter months, for example, low temperatures tend to stiffen and reduce the flexibility of the asphalt binder in the paving material. Under these conditions (and with traffic loadings), the compacted mixture tends to crack, allowing surface water to seep into the pavement. As the water goes through freeze-thaw cycles, it strips the bituminous binder, e.g., asphalt, from the aggregate mixture, reducing the strength of the compacted mixture and accelerating deterioration. In addition, during the summer months, high temperatures can cause the asphalt pavement to become so soft that traffic can permanently deform the material creating shoving, rutting, bleeding and flushing problems.

To aid adherence of the binder to the aggregate, the aggregate mixture and/or the bituminous binder may be treated with an antistripping additive. Conventional antistripping additives reduce stripping by acting as a binding agent between the aggregate granules and bituminous binder. Examples of commonly used antistripping additives include surfactants and ethyleneamines, which are added to the aggregate mixture and/or bituminous binder, e.g., when heated. Conventional antistripping additives are undesirable, however, as they provide inadequate protection from water as tested by any of numerous moisture susceptibility test procedures, e.g., ASTM D 3625 (boiling water test), AASHTO T 283 (modified Lottman test), AASHTO T 324 (Hamburg wheel tracking test), ASTM D 4867 (Tunnicliff and Root conditioning test), AASHTO T 182 (static-immersion test), and AASHTO T 165 (immersion-compression test). In addition, conventional antistripping additives are not effective for all types of bituminous aggregate mixtures, e.g., for HMA, WMA, and cold-mix asphalt concrete. For example, some conventional antistripping additives are not thermally stable and therefore are not suitable for HMA.

US Publication No. 2022/0112129A1 discloses antistripping compositions that may be used, for example, as additives to bitumen compositions such as asphalt concrete to prevent or reduce susceptibility to water damage. In particular, the antistripping compositions have a triamine component and a nitrile component. Also disclosed are bitumen compositions, such as asphalt, having the described antistripping compositions as an additive.

U.S. Pat. No. 4,906,783 discloses the preparation of bis(hexamethylene)triamine from 6-aminohexanenitrile by catalytically preparing di(5-cyanopentyl)-amine, followed by hydrogenation using a nitride hydrogenation catalyst.

Even in view of the references, there is a need for improved antistripping compositions that improve the moisture resistance and/or thermal stability of bituminous aggregate mixtures, e.g., asphalt, while advantageously reducing nitrile content, which provides for reductions in processing problems and overall cost.

### SUMMARY

In some cases, the disclosure relates to an antistripping composition, comprising a first triamine compound, or a second amine compound different from the first triamine compound, and less than 1 wt % of a nitrile compound (for example tricyanohexane), e.g., less than 0.1 wt %, and, optionally, an organic additive. The first triamine compound may comprise di(4-amino-butyl)amine, di(5-amino-pentyl)amine, di(6-amino-hexyl)amine, e.g., bis(hexamethylene(triamine)), di(7-amino-heptyl)amine, di(8-amino-octyl)amine, (4-amino-butyl)(5-amino-pentyl)amine, (4-amino-butyl)(6-amino-hexyl)amine, bis(hexamethylene)triamine (BHMT), (4-amino-butyl)(7-amino-heptyl)amine, (4-amino-butyl)(8-amino-octyl)amine, (5-amino-pentyl)(6-amino-hexyl)amine, (5-amino-pentyl)(7-amino-heptyl)amine, or (5-amino-pentyl)(8-amino-octyl)amine, or combinations thereof and/or may have the chemical structure:

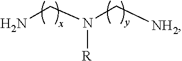

e.g., BHMT. The second amine compound comprises an alkane amine or an alkene amine, e.g., triaminononane such as a compound that has the structure:

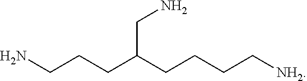 [SMILES: NCCCCC(CN)CCCN]

The organic additive may comprise a vegetable oil comprising canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, or linseed oil, or combinations thereof; and/or an ester having a chemical structure:

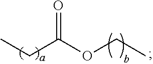

wherein a and b are independently from 0 to 4, in particular, the organic additive may be ethanol, propanol, or an alkylene glycol, or corresponding esters of thereof, or combinations thereof. The organic additive may comprise from 2 wt % to 20 wt % based on the total weight of the antistripping composition. The disclosure also relates to a bitumen composition, comprising a bituminous material; and (from 0.1 wt % to 5 wt % of) the antistripping composition. The antistripping composition may comprise the first triamine compound in an amount ranging from 10 wt % to 80 wt % based on the total weight of the antistripping composition; and the second amine compound in an amount ranging from 10 wt % to 80 wt % based on the total weight of the antistripping composition. The bitumen composition may exhibit at least 50% coating retention, measured according to ASTM D 3625 (2020) and/or a tensile strength ratio greater than 80%, measured according to AASHTO T 283 (2022). The disclosure also relates to a process for improving durability in a bitumen composition comprising a bituminous material, the process comprising adding the antistripping composition to the bitumen composition to form a treated bitumen composition, wherein, upon aging for 40 days, the treated bitumen composition demonstrates a BBR stiffness less than 247 MPa, as measured in accordance with AASHTO T 313 (2022).

### DETAILED DESCRIPTION

### Introduction

As noted above, it has been well-established that the exposure of a traditional bituminous aggregate mixture, such as asphalt concrete, to moisture deteriorates paved and compacted surfaces formed from the mixture. This is because water and/or water vapor may cause the separation of the bituminous binder, e.g., asphalt, from the aggregate, a phenomenon known in the art as “stripping.” Stripping then contributes to various distress mechanisms that lead to the deterioration and ultimate failure of the bituminous aggregate mixture, such as rutting, fatigue cracking, and thermal cracking.

Bis(hexamethylene)triamine (BHMT) is a known component of some conventional antistripping compositions. The performance of these conventional compositions, however, leaves much room for improvement. Other conventional antistripping composition utilize triamines, e.g., BHMT, along with a significant nitrile, e.g., tricyanohexane (TCH), content. In some cases, such nitriles are known to be difficult to process along with some amines and, in some cases, expensive. The addition of compounds having nitrile functionality has been found, in some cases, to create processing issues such as maintenance of the overall liquid state and/or difficulties in mixing due to viscosities between components. In particular, some TCH isomers/grades may be significantly more viscous, which creates difficulties in forming a low viscosity (liquid state) antistripping composition. Stated another way, the employment of TCH, in certain compositions, may result in a less desirable high viscosity (or even solid) antistripping composition.

Moreover, it has been discovered that antistripping compositions comprising higher amounts of nitriles lead to reduced interaction with aggregates, which in turn diminishes performance. And, as noted above, supply chain issues often affect certain nitrile compounds, e.g., tricyanohexane, more detrimentally. As a result, the demand for these nitriles raises the price thereof, thus making their use impractical.

The inventors have now found that other specific amines, e.g., triaminononane, are particularly useful as antistripping agents. In some cases, these amines demonstrate unexpected performance improvements when employed with other (non-nitrile) components. In other cases, these amines are useful standing alone. Importantly, it has been discovered that when these amines are utilized, nitrile content can be reduced or eliminated, which provides for aforementioned benefits.

### Antistripping Compositions

The present disclosure relates to compositions and methods for reducing or mitigating stripping of bituminous aggregate mixtures, such as asphalt concrete (antistripping compositions).

In particular, the present disclosure describes antistripping compositions comprising a first (triamine) compound a second (amine) compound that is different from the first triamine compound; and low amounts, if any, nitrile compound, which beneficially reduce or eliminate the susceptibility of a bituminous aggregate mixture to moisture, while advantageously reducing or eliminating the problems and costs associated with nitrile compounds. Furthermore, the present disclosure describes bitumen compositions that comprise the antistripping compositions and that demonstrate improved performance characteristics as a result of the addition of the antistripping compositions. The present inventors have found that the antistripping compositions described herein, as well as the bitumen compositions comprising the antistripping compositions, exhibit improved resistance to the negative effects of moisture as measured by a variety of performance metrics.

Without being bound by theory, it is believed that the structure of the components within the antistripping composition prevent water from replacing the bituminous binder as the coating surrounding the aggregate in a bituminous aggregate mixture. As detailed further below, the components are different organic compounds each of which contain one or more amine moieties. And the difference in structure have been found to be unexpectedly advantageous.

In theory, the organic portion is soluble in the bituminous binder, e.g., asphalt, and is anchored therein, whereas amine moieties have an affinity for the aggregates. And the positioning and configuration of the different amines has been found to promote this anchoring—even more so than in conventional compositions that employ triamines and nitriles. As a result, the antistripping compositions provide an improvement in the security of the bond between in the bitumen binder and the aggregate, preventing water from separating the bituminous binder from the aggregate.

In some cases, the antistripping compositions described herein beneficially form stable solutions that remain liquid, e.g., at or below room temperature. As a result, the antistripping compositions described herein exhibit improved thermal stability.

Described herein are a number of triamine compounds, which the present inventors have found favorably prevent, reduce, or eliminate the stripping of bitumen compositions, e.g., bituminous aggregate mixtures, such as asphalt concrete, and/or provide for the improved thermal stability of the bitumen compositions.

### First Triamine Compound

As such, the triamine compounds are useful as components of antistripping compositions. Thus, the antistripping compositions described herein comprise specific amines, e.g., the first aforementioned triamine compound and second amine compounds.

It is postulated that, in some cases, the presence of the triple amine moieties (either in the first triamine compound and/or in the second amine compound) provides unexpected improvements in securing the bond between the bitumen binder and the aggregate versus other amines containing fewer amino functional groups.

The first triamine compound may vary widely. In some embodiments, the first triamine compound comprises molecules having three amino groups per molecule. In some cases, the triamine compound has the chemical structure:

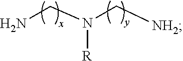

wherein x and y are independently from 1 to 10, and wherein R is hydrogen, a C₁-C₅ alkyl group, a C₂-C₅ alkenyl group, or a C₁-C₅ alcohol group. In some embodiments, R is hydrogen.

The first triamine compound may comprise one or more first triamines.

In some cases, the triamine compound may be, for example, di(4-amino-butyl)amine, di(5-amino-pentyl)amine, di(6-amino-hexyl)amine, e.g., bis(hexamethylene(triamine)), di(7-amino-heptyl)amine, di(8-amino-octyl)amine, (4-amino-butyl)(5-amino-pentyl)amine, (4-amino-butyl)(6-amino-hexyl)amine, bis(hexamethylene)triamine (BHMT), dipropylenetriamine (DPT), (4-amino-butyl)(7-amino-heptyl)amine, (4-amino-butyl)(8-amino-octyl)amine, (5-amino-pentyl)(6-amino-hexyl)amine, (5-amino-pentyl)(7-amino-heptyl)amine, or (5-amino-pentyl)(8-amino-octyl)amine. In some cases, the triamine compound comprises BHMT.

In some embodiments, the first triamine compound is present in an amount ranging from 10 wt % to 80 wt %, based on the total weight of the antistripping composition, e.g., from 20 wt % to 80 wt %, from 25 wt %, to 75 wt %, from 30 wt % to 70 wt %, from 35 wt % to 65 wt %, from 40 wt % to 60 wt %, from 45 wt %, to 55 wt %, from 15 wt % to 50 wt %, from 20 wt % to 45 wt %, from 15 wt % to 40 wt %, from 20 wt % to 35 wt %, from 25 wt % to 30 wt %, from 15 wt % to 35 wt %, or from 20 wt % to 30 wt %.

In terms of upper limits, the first triamine compound may be present in an amount less than 90 wt %, e.g., less than 85 wt %, less than 80 wt %, less than 75 wt %, less than 70 wt %, less than 65 wt %, less than 60 wt %, less than 55 wt %, less than 50 wt %, less than 45 wt %, less than 40 wt %, less than 35 wt %, less than 30 wt %, less than 25 wt %, less than 20 wt %, or less than 15 wt %.

In terms of lower limits, the first triamine compound may be present in an amount greater than 10 wt %, e.g., greater than 15 wt %, greater than 20 wt %, greater than 25 wt %, greater than 30 wt %, greater than 35 wt %, greater than 40 wt %, greater than 50 wt %, greater than 55 wt %, greater than 60 wt %, greater than 65 wt %, greater than 70 wt %, greater than 75 wt %, or greater than 80 wt %.

The first triamine compound can comprise BHMT and a synergist. BHMT itself is a known chemical compound. Importantly, BHMT does not have cyclic moieties.

In some embodiments, the adhesive composition comprises less than 35 wt % cyclic amines, e.g., less than 30 wt %, less than 25 wt %, less than 20 wt %, less than 15 wt %, less than 10 wt %, less than 5 wt %, or less than 1 wt %. In some cases, the adhesive composition no cyclic amine content. In terms of ranges, the adhesive composition comprises from 0 wt % to 35 wt % cyclic amines, e.g., from 0.1 wt % to 35 wt %, from 0.1 wt % to 25 wt %, from 0.1 wt % to 10 wt %, from 1 wt % to 25 wt %, from 1 wt % to 10 wt %, from 0.1 wt % to 5 wt %, from 1 wt % to 5 wt %, or from 0.1 wt % to 3 wt %. Without being bound by theory, it is posited that the lack of bulky cyclic moieties on the amines of the first triamine compound (and in the adhesive composition as a whole) provides for improved interaction with the epoxy groups of the epoxy resin. This improved interaction provides for closer molecular interaction, which in turn provides for better sag resistance and/or viscosity control. By employing the disclosed first triamine compound that has little if any cyclic amine content, the adhesive compositions are able to achieve the aforementioned performance benefits.

In some cases, the hydrocarbon chains between the amino groups are beneficially long (versus, for example, ethylene or propylene amines), which may provide for improved inter-molecular interactions between polymer chains. In some cases, at least some of the hydrocarbon chains between the amino groups, comprise greater than 3 carbons, e.g., greater than 4, greater than 5, greater than 6, greater than 7, or greater than 8.

The cyclic amine content may also be characterized in terms of total amine content. In some cases, the adhesive composition comprises less than 75% cyclic amines, based on the total amine content (cyclic amine content/total amine content), e.g., less than 65%, less than 60%, less than 50%, less than 40%, less than 35%, less than 25%, less than 20%, less than 15%, less than 10%, less than 5%, or less than 1%. In terms of ranges, the adhesive composition comprises from 0% to 75% cyclic amines, based on total amine content, e.g., from 0.1% to 75%, from 0.1% to 50%, from 0.1% to 20%, from 1 wt % to 20%, from 1% to 10%, from 0.1% to 10%, from 0.1 wt % to 5%, or from 1% to 3%.

In some cases, the first triamine compound also comprises a synergist. It has been found that the combination of the synergist improves performance of the BHMT (and the interaction with the epoxy groups). The synergist may be present in the amounts disclosed above in relation to the BHMT.

The synergist may vary widely. In some cases, the synergist is a nitrogen-containing compound. In some embodiments, the synergist comprises acetonitrile, caprolactam, aminohexanol, or aminocephalosporanic acid, or combinations thereof. In some cases, the synergist comprises hexamethylenediamine (HMD), aminocapronitrile, or adiponitrile, or combinations thereof.

In some cases, the synergist may include aliphatic, cycloaliphatic or arylaliphatic primary diamines, such as ethylene diamine, 1,2-propane diamine, 1,3-propane diamine, 2-methyl-1,2-propane diamine, 2,2-dimethyl-1,3-propane diamine, 1,3-butane diamine, 1,4-butane diamine, 1,3-pentane diamine (DAMP), 1,5-pentane diamine, 1,5-diamino-2-methylpentane (MPMD), 2-butyl-2-ethyl-1,5-pentane diamine (C11-Neodiamine), 1,6-hexane diamine, 2,5-dimethyl-1,6-hexane diamine, 2,2,4- and 2,4,4-trimethylhexamethylene diamine (TMD), 1,7-heptane diamine, 1,8-octane diamine, 1,9-nonane diamine, 1,10-decane diamine, 1,11-undecane diamine, 1,12-dodecane diamine, 1,2-, 1,3- and 1,4-diaminocyclohexane, bis-(4-aminocyclohexyl)methane (H12-MDA), bis-(4-amino-3-methylcyclohexyl)methane, bis-(4-amino-3-ethylcyclohexyl)methane, bis-(4-amino-3,5-dimethylcyclohexyl)methane, bis-(4-amino-3-ethyl-5-methylcyclohexyl)methane (M-MECA), 1-amino-3-aminomethyl-3,5,5-trimethylcyclohexane (=isophorone diamine or IPDA), 2- and 4-methyl-1,3-diaminocyclohexane and mixtures thereof, 1,3- and 1,4-bis-(amino-methyl)cyclohexane, 2,5(2,6)-bis-(aminomethyl)bicyclo[2.2.1]heptane (NBDA), 3(4), 8(9)-bis-(aminomethyl)tricyclo[5.2.1.02,6]decane, 1,4-diamino-2,2,6-trimethylcyclohexane (TMCDA), 1,8-menthane diamine, 3,9-bis-(3-aminopropyl)-2,4,8,10-tetraoxaspiro[5.5]undecane as well as 1,3- and 1,4-bis-(aminomethyl)benzene.

In some cases, the synergist may include aliphatic, cycloaliphatic or arylaliphatic primary triamines like 4-aminomethyl-1,8-octane diamine, 1,3,5-tris-(aminomethyl)benzene, 1,3,5-tris-(aminomethyl)cyclohexane, tris-(2-aminoethyl)amine, tris-(2-aminopropyl)amine and tris-(3-aminopropyl)amine.

In some cases, the synergist may include aliphatic primary diamines containing ether groups, such as especially bis-(2-aminoethyl)-ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine and higher oligomers of these diamines, bis-(3-aminopropyl)polytetrahydrofurans and other polytetrahydrofuran diamines, as well as polyoxyalkylene diamines. The latter typically constitute products from the amination of polyoxyalkylene diols and are available for example under the names Jeffamine® (from Huntsman), under the name Polyetheramine (from BASF) or under the name PC Amine® (from Nitroil). Especially suitable polyoxyalkylene diamines are Jeffamine® D-230, Jeffamine® D-400, Jeffamine® D-2000, Jeffamine® D-4000, Jeffamine® XTJ-511, Jeffamine® ED-600, Jeffamine® ED-900, Jeffamine ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, Jeffamine® EDR-104, Jeffamine® EDR-148, Jeffamine® EDR-176; Polyetheramine D 230, Polyetheramine D 400 and Polyetheramine D 2000, PC Amine® DA 250, PC Amine® DA 400, PC Amine® DA 650 and PC Amine® DA 2000.

In some cases, the synergist may include primary polyoxyalkylene triamines, which typically constitute products from the amination of polyoxyalkylene triols and are available for example under the name Jeffamine® (from Huntsman), under the name polyetheramine (from BASF) or under the name PC Amine® (from Nitroil), such as in particular Jeffamine® T-403, Jeffamine T-3000, Jeffamine® T-5000, Polyetheramine T 403, Polyetheramine T 5000 and PC Amine® TA 403.

In some cases, the synergist may include polyamines having tertiary amino groups with two primary aliphatic amino groups, such as in particular N,N′-bis-(aminopropyl)-piperazine, N,N-bis-(3-aminopropyl)methylamine, N,N-bis-(3-aminopropyl)ethylamine, N,N-bis-(3-aminopropyl)propylamine, N,N-bis-(3-aminopropyl)cyclohexylamine, N,N-bis-(3-aminopropyl)-2-ethyl-hexylamine, as well as the products from the double cyanoethylation and subsequent reduction of fatty amines, which are derived from natural fatty acids, such as N,N-bis-(3-aminopropyl)dodecylamine and N,N-bis-(3-aminopropyl) tallow-alkylamine, available as Triameen® Y2D and Triameen® YT (from Akzo Nobel).

In some cases, the synergist may include polyamines having tertiary amino groups with three primary aliphatic amino groups, such as in particular tris-(2-aminoethyl)amine, tris-(2-aminopropyl)amine and tris-(3-aminopropyl)amine; polyamines having secondary amino groups with two primary aliphatic amino groups, such as in particular 3-(2-aminoethyl)aminopropylamine, diethylene triamine (DETA), triethylene tetramine (TETA), tetraethylene pentamine (TEPA), pentaethylene hexamine (PEHA) and higher homologues of linear polyethylene amines like polyethylene polyamine with 5 to 7 ethylene amine units (so-called “higher ethylene-polyamines”, HEPA), products from the multiple cyanoethylation or cyanobutylation and subsequent hydrogenation of primary di- and polyamines with at least two primary amino groups, such as dipropylene triamine (DPTA), N-(2-aminoethyl)-1,3-propane diamine (N3-amine), N,N′-bis(3-aminopropyl)ethylene diamine (N4-amine), N,N′-bis-(3-aminopropyl)-1,4-diaminobutane, N5-(3-aminopropyl)-2-methyl-1,5-pentane diamine, N3-(3-aminopentyl)-1,3-pentane diamine, N5-(3-amino−1-ethylpropyl)-2-methyl-1,5-pentane diamine and N,N′-bis-(3-amino−1-ethylpropyl)-2-methyl-1,5-pentane diamine.

In some cases, the synergist may include polyamines having one primary and one secondary amino group, such as in particular N-methyl-1,2-ethane diamine, N-ethyl-1,2-ethane diamine, N-butyl-1,2-ethane diamine, N-hexyl-1,2-ethane diamine, N-(2-ethylhexyl)-1,2-ethane diamine, N-cyclohexyl-1,2-ethane diamine, 4-aminomethyl-piperidine, N-(2-aminoethyl)piperazine, N-methyl-1,3-propane diamine, N-butyl-1,3-propane diamine, N-(2-ethylhexyl)-1,3-propane diamine, N-cyclohexyl-1,3-propane diamine, 3-methylamino-1-pentylamine, 3-ethylamino-1-pentylamine, 3-cyclohexylamino-1-pentylamine, fatty diamines like N-cocoalkyl-1,3-propane diamine and products from the Michael-type addition reaction of primary aliphatic diamines with acrylonitrile, maleic or fumaric acid diesters, citraconic acid diesters, acrylic and methacrylic acid esters, acrylic and methacrylic acid amides and itaconic acid diesters, reacted in a molar ratio of 1:1, and also products from the partial reductive alkylation of primary aliphatic polyamines with benzaldehyde or other aldehydes or ketones, as well as partially styrolized polyamines like Gaskamine® 240 (from Mitsubishi Gas Chemical (MGC)).

In some cases, the synergist may include aromatic polyamines, especially such as m- and p-phenylene diamine, 4,4′-, 2,4′ and 2,2′-diaminodiphenylmethane, 3,3′-dichloro-4,4′-diaminodiphenylmethane (MOCA), 2,4- and 2,6-toluylene diamine, mixtures of 3,5-dimethylthio-2,4- and -2,6-toluylene diamine (available as Ethacure® 300 from Albemarle), mixtures of 3,5-diethyl-2,4- and -2,6-toluylene diamine (DETDA), 3,3′,5,5′-tetraethyl-4,4′-diaminodiphenylmethane (M-DEA), 3,3′,5,5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′,5,5′-tetraisopropyl-4,4′-diaminodiphenylmethane (M-DIPA), 4,4′-diaminodiphenylsulfone (DDS), 4-amino-N-(4-aminophenyl)benzene sulfonamide, 5,5′-methylene dianthranilic acid, dimethyl-(5,5′-methylene dianthranilate), 1,3-propylene-bis-(4-aminobenzoate), 1,4-butylene-bis-(4-aminobenzoate), polytetramethylene oxide-bis-(4-aminobenzoate) (available as Versalink® from Air Products), 1,2-bis-(2-aminophenylthio)ethane, 2-methylpropyl-(4-chloro-3,5-diaminobenzoate) and tert.butyl-(4-chloro-3,5-diaminobenzoate).

In some cases, the synergist may include adducts of the mentioned polyamines with epoxides and epoxy resins, especially adducts with diepoxides in a molar ratio of at least 2/1, adducts with monoepoxides in a molar ratio of at least 1/1, and reaction products from amines and epichlorhydrin, especially that of 1,3-bis-(aminomethyl)benzene, commercially available as Gaskamine® 328 (from MGC).

In some cases, the synergist may include polyamidoamines, which constitute reaction products of a monovalent or polyvalent carboxylic acid, or its esters or anhydrides, especially a dimer fatty acid, and an aliphatic, cycloaliphatic or aromatic polyamine used in stoichiometric excess, especially a polyalkylene amine such as DETA or TETA, especially the commercially available polyamidoamines Versamid® 100, 125, 140 and 150 (from Cognis), Aradur® 223, 250 and 848 (from Huntsman), Euretek® 3607 and 530 (from Huntsman) and Beckopox® EH 651, EH 654, EH 655, EH 661 and EH 663 (from Cytec).

In some cases, the synergist may include phenalkamines, also known as Mannich bases, which constitute reaction products of a Mannich reaction of phenols, especially cardanol, with aldehydes, especially formaldehyde, and polyamines, especially the commercially available phenalkamines Cardolite® NC-541, NC-557, NC-558, NC-566, Lite 2001 and Lite 2002 (from Cardolite), Aradur® 3440, 3441, 3442 and 3460 (from Huntsman) and Beckopox® EH 614, EH 621, EH 624, EH 628 and EH 629 (from Cytec).

In cases where the synergist may be a cyclic amine, the cyclic amine is present in the lower amounts disclosed herein.

In some cases, the first triamine compound may comprise BHMT in an amount ranging from 30 wt % to 90 wt % wt %, based on the total weight of the first triamine compound, e.g., from 35 wt % to 80 wt %, from 40 wt % to 75 wt %, from 45 wt % to 70 wt %, from 50 wt % to 65 wt %, or from 52 wt % to 57 wt %. In terms of lower limits, the first triamine compound may comprise greater than 30 wt % BHMT, e.g., greater than 35 wt %, greater than 40 wt %, greater than 45 wt %, greater than 50 wt %, greater than 55 wt %, greater than 60 wt %, greater than 65 wt %, greater than 70 wt %, greater than 75 wt %, or greater than 80 wt %. In terms of upper limits, the first triamine compound may comprise less than 90 wt % BHMT, e.g., less than 85 wt %, less than 80 wt %, less than 75 wt %, less than 70 wt %, less than 65 wt %, less than 60 wt %, less than 55 wt %, less than 50 wt %, less than 45 wt %, or less than 40 wt %.

The first triamine compound may comprise the synergist in an amount ranging from 10 wt % to 70 wt %, based on the total weight of the first triamine compound, e.g., from 15 wt % to 65 wt %, from 20 wt % to 60 wt %, from 25 wt % to 55 wt %, from 30 wt % to 50 wt %, or from 35 wt % to 45 wt %. In terms of lower limits, the first triamine compound may comprise greater than 10 wt % synergist, e.g., greater than 15 wt %, greater than 20 wt %, greater than 25 wt %, greater than 30 wt %, greater than 35 wt %, greater than 40 wt %, greater than 45 wt %, greater than 50 wt %, or greater than 55 wt %. In terms of upper limits, the first triamine compound may comprise less than 70 wt % synergist, e.g., less than 65 wt %, less than 60 wt %, less than 55 wt %, less than 50 wt %, less than 45 wt %, less than 40 wt %, less than 35 wt %, less than 30 wt %, less than 25 wt %, less than 20 wt %, less than 15 wt %, or less than 10 wt %. These ranges and limits are applicable to the synergist as a whole and also to the specific chemicals individually.

In some cases, the synergist comprises, low amounts, e.g., less than 15 wt % (based on the total weight of the first triamine and the synergist as a whole), of aminocapronitrile, HMD, adiponitrile, acetonitrile, aminohexanol, or aminocephalosporanic acid, or combinations thereof, and optional organics in even smaller amounts.

Commercial products of the first triamine compound include BHM L-500, which is a composition comprises BHMT and synergist. In some cases, the synergist comprises, low amounts, e.g., less than 15 wt %, of aminocapronitrile, HMD, adiponitrile, acetonitrile, aminohexanol, or aminocephalosporanic acid, or combinations thereof, and optional organics in even smaller amounts.

### Second Amine Compound

In some embodiments, the antistripping compositions may comprise the second amine compound. In some embodiments, the antistripping composition comprise the second amine compound alone and do not comprise the first triamine compound.

In some cases, these second amine compounds demonstrate unexpected performance improvements when employed with other (non-nitrile) components. In other cases, these second amines are useful without other (non-nitrile) components.

The second amine compound may vary widely. The second amine compound may vary widely, but generally, it will have amino or nitrogen functionality. For example, the second amine compound may be an organic compound having amino, or nitrogen, functional groups on a saturated or unsaturated chain of carbon atoms.

The second amine shall be different from the first triamine. The second amine may, in some cases, be a triamine (different from the first triamine), but in other cases, may be a diamine or a monoamine. The second amine compound may comprise one or more second amines.

For example, in some embodiments, the second amine compound comprises an alkane triamine, e.g., an organic compound having the chemical formula CₓH₂ₓ₊₅N₃, wherein x is from 6 to 20. Exemplary alkane amines include triamino hexane, triamino heptane, triamino octane, triamino nonane, triamino decane, triamino undecane, triamino dodecane, triamino tridecane, triamino pentadecane, triamino hexadecane, triamino heptadecane, triamino octadecane, triamino nonadecane, and triamino icosane. Similar di- and mono-alkane amines are also contemplated, e.g., diamino alkanes, and monoamino alkanes.

In some embodiments, the second amine compound comprises an alkene amine, e.g., an unsaturated organic compound having the chemical formula CₓH₂ₓ₊₃N₃, wherein x is from 6 to 20. Exemplary alkene amines include triamino hexene, triamino heptene, triamino octene, triamino nonene, triamino decene, triamino undecene, triamino dodecene, triamino tridecene, triamino pentadecene, triamino hexadecene, triamino heptadecene, triamino octadecene, triamino nonadecene, and triamino icosene. Similar di- and mono-alkene amines are also contemplated, e.g., diamino alkenes, and monoamino alkenes.

In some cases, the second amine compound has the structure:

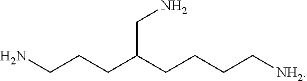 [SMILES: NCCCCC(CN)CCCN]

In some embodiments, the second amine compound comprises an aryl amine, e.g., an aromatic organic compound having amino, or nitrogen, functional groups.

In some embodiments, the second amine compound is present in an amount similar to that of the first triamine compound. In some cases, the second amine compound is present in an amount less than that of the first triamine compound. In some cases, the second amine compound is present in an amount greater than that of the first triamine compound.

In some embodiments, the second amine compound may comprise a diamine compound. Exemplary diamine compounds include ethane diamine, propane diamine, butane diamine, pentane diamine, hexane diamine, hexamethylene diamine, heptane diamine, octane diamine, nonane diamine, and decane diamine.

In some embodiments, the second amine compound (or the composition generally) comprises nitrogen-containing compounds that are not triamines, e.g., not the triamines disclosed herein. For example, these nitrogen-containing compounds may comprise acetonitrile, caprolactam, aminohexanol, e.g., 6-Amino-1-hexanol, (AMOL) or aminocephalosporanic acid (ACA) or combinations thereof. Surprisingly, the presence of these nitrogen-containing compounds has been found to advantageously affect antistripping performance, e.g., carbonyl index performance, BBR stiffness, and/or BBR M value. As the examples show, antistripping compositions that comprise the disclosed triamines, optionally along with one or more of the synergistic nitrogen-containing compounds perform significantly better than conventional amines, e.g., diamines, in these applications.

As noted above, in some cases, the antistripping composition comprises the second amine (and does not comprise the first triamine). Thus, the antistripping composition comprises the second amine compound, e.g., an amine compound comprising an alkane triamine or an alkene triamine or a combination thereof and low amounts of nitrile compound, e.g., less than 1 wt %.

These nitrogen-containing compounds may be present in the antistripping composition in an amount ranging from 0.01 wt % to 50 wt %, e.g., from 0.1 wt % to 50 wt %, from 1 wt % to 40 wt %, from 5 wt % to 40 wt %, from 10 wt % to 40 wt %, or from 10 wt % to 36 wt %. In terms of lower limits, the nitrogen-containing compounds may be present in the antistripping composition in an amount greater than 0.01 wt %, e.g., greater than 0.01 wt %, greater than 1 wt %, greater than 5 wt %, greater than 10 wt %, greater than 15 wt %, greater than 20 wt %, greater than 25 wt %, greater than 30 wt %, or greater than 40 wt %. In terms of upper limits, the nitrogen-containing compounds may be present in the antistripping composition in an amount less than 50 wt %, e.g., less than 45 wt %, less than 40 wt %, less than 35 wt %, less than 30 wt %, less than 25 wt %, less than 20 wt %, less than 15 wt %, less than 10 wt %, less than 5 wt %, less than 1 wt %, or less than 0.1 wt %. These ranges and limits apply to the nitrogen-containing compounds individually or collectively.

Commercial products of the second amine compound include Hexatran, which comprises triaminononane (TAN).

### Low Nitrile Content

As noted above, the disclosed antistripping compositions comprise low amounts, if any, nitriles, which contributes to the aforementioned benefits. The inventors have discovered that minimizing nitrile content unexpectedly improves processing issues, e.g., the aforementioned viscosity-related and aggregate interaction issues, and also provides for commercial benefits.

In some cases, the antistripping compositions comprise less than 1 wt % nitriles, e.g., less than 0.8 wt %, less than 0.5 wt %, less than 0.3 wt %, less than 0.1 wt %, less than 0.07 wt %, less than 0.05 wt %, less than 0.03 wt %, or less than 0.01 wt %. These limits are applicable to nitriles as a whole or individual nitriles or combinations of select nitriles.

In some embodiments, the nitrile compounds that are present in small amounts, if at all, are trinitrile compounds, e.g., an organic compound having three cyano, or nitrile, functional groups on a saturated or unsaturated chain of carbon atoms. For example, in some embodiments, the nitrile component comprises a trinitrile alkane, e.g., an organic compound having the chemical formula CₓH₂ₓ₋₁(CN)₃, wherein x is from 4 to 10. Exemplary trinitrile compounds include butane trinitrile, e.g., tricyanobutane, pentane trinitrile, e.g., tricyanopentane, hexane trinitrile, e.g., tricyanohexane, heptane trinitrile, e.g., tricyanoheptane, octane trinitrile, e.g., tricyanooctane, nonane trinitrile, e.g., tricyanononane, and decane trinitrile, e.g., tricyanodecane, and combinations thereof. In some embodiments the trinitrile compound comprises tricyanohexane, e.g., 1,3,6-tricyanohexane and/or 1,3,5-tricyanohexane.

### Organic Additive

In some embodiments, the antistripping composition further comprises an (optional) organic additive. In some cases, the addition of an organic additive, as described herein, unexpectedly improves the ability of the antistripping composition to reduce or eliminate the moisture susceptibility of a bituminous aggregate mixture (such as asphalt concrete). In particular, the organic additive may lower the melting point of the antistripping composition. As a result, the organic additive may ensure that the antistripping composition remains in a liquid state. Thus, the antistripping compositions described herein exhibit greater thermal stability relative to conventional antistripping additives.

The organic additive may comprise, for example, a vegetable oil. The composition of the vegetable oil used in the organic additive is not particularly limited, and any long chain hydrocarbon, e.g., triglycerides, extracted or derived from plant matter may be used. Exemplary vegetable oils suitable for use in the antistripping composition include canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, linseed oil, and combinations thereof. In some particular embodiments, the antistripping composition comprises soy oil.

The organic additive may comprise, for example, an ester. The composition of the ester used in the organic additive is not particularly limited. In some cases, the ester comprises a carboxylate ester, an orthoester, a phosphate ester, a sulfate ester, a nitrate ester, a borate, a carbonate ester, or combinations thereof.

In some embodiments, the organic additive comprises an ester having the chemical structure:

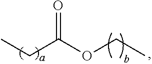

wherein a and b are independently from 0 to 4. Exemplary esters according to the above structure include methyl acetate, methyl propionate, methyl butyrate, methyl valerate, methyl caproate, ethyl acetate, ethyl propionate, ethyl butyrate, ethyl valerate, ethyl caproate, propyl acetate, propyl propionate, propyl butyrate, propyl valerate, propyl caproate, butyl acetate, butyl propionate, butyl butyrate, butyl valerate, butyl caproate, pentyl acetate, pentyl propionate, pentyl butyrate, pentyl valerate, pentyl caproate, and combinations thereof.

In some embodiments, the organic additive comprises an ester having the chemical structure:

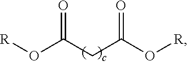

wherein c is from 1 to 8, and wherein each R is independently a C₁-C₃ alkyl group, a C₂-C₄ alkenyl group, or a C₁-C₃ alcohol group. Exemplary esters according to the above structure include dimethyl malonate, dimethyl succinate, dimethyl glutarate, dimethyl adipate, dimethyl pimelate, dimethyl suberate, diethyl malonate, diethyl succinate, diethyl glutarate, diethyl adipate, diethyl pimelate, diethyl suberate, dipropyl malonate, dipropyl succinate, dipropyl glutarate, dipropyl adipate, dipropyl pimelate, dipropyl suberate, ethyl methyl malonate, ethyl methyl succinate, ethyl methyl glutarate, ethyl methyl aethylpate, ethyl methyl pimelate, ethyl methyl suberate, and combinations thereof.

In some embodiments, the organic additive comprises an alcohol. As some examples, the organic additive may be the corresponding alcohol of the aforementioned esters. For example, the alcohol may include at least one of a methanol, an ethanol, a N-propanol, a butanol, pentanol, hexanol, an octanol, an N-octanol, a tetrahydrofurfuryl alcohol (THFA), a cyclohexanol, a cyclopentanol, and a terpineol. The N-propanol may include at least one of a 1-propanol, a 2-propanol, and a 1-methoxy-2-propanol. The butanol may include at least one of a 1-butanol and a 2-butanol. The pentanol may include at least one of a 1-pentanol, a 2-pentanol, and a 3-pentanol. The hexanol may include at least one of a 1-hexanol, a 2-hexanol, and a 3-hexanol. The N-octanol may include at least one of a 1-octanol, a 2-octanol, and a 3-octanol.

In some embodiments, the alcohol comprises ethanol, propanol, or alkylene glycols, or combinations thereof. In some cases, the organic additive comprises ethanol, propanol, or alkylene glycols, or corresponding esters of thereof, or combinations thereof.

In some embodiments, the organic additive comprises a vegetable oil and an ester. For example, the organic additive may comprise soy oil and ethyl acetate. In these embodiments, the relative content of the vegetable oil and the ester are not particular limited and may, for example, be (approximately) equal.

The content of the organic additive in the antistripping composition is not particularly limited and may vary widely. In one embodiment, the antistripping composition comprises from 0 wt % to 20 wt % of the organic additive, e.g., from 0 wt % to 19 wt %, from 0 wt % to 18 wt % from 0 wt % to 17 wt % from 0 wt % to 16 wt %, from 0 wt % to 15 wt %, from 1 wt % to 20 wt %, from 1 wt % to 19 wt %, from 1 wt % to 18 wt % from 1 wt % to 17 wt % from 1 wt % to 16 wt %, from 1 wt % to 15 wt %, from 2 wt % to 20 wt %, from 2 wt % to 19 wt %, from 2 wt % to 18 wt % from 2 wt % to 17 wt % from 2 wt % to 16 wt %, from 2 wt % to 15 wt %, from 3 wt % to 20 wt %, from 3 wt % to 19 wt %, from 3 wt % to 18 wt % from 3 wt % to 17 wt % from 3 wt % to 16 wt %, from 3 wt % to 15 wt %, from 4 wt % to 20 wt %, from 4 wt % to 19 wt %, from 4 wt % to 18 wt % from 4 wt % to 17 wt % from 4 wt % to 16 wt %, or from 4 wt % to 15 wt %. In terms of lower limits, the antistripping composition may comprise greater than 0 wt %, of the organic additive, e.g., greater than 1 wt %, greater than 2 wt %, greater than 3 wt %, or greater than 4 wt %. In terms of upper limits, the antistripping composition may comprise less than 20 wt % of the organic additive, e.g. less than 19 wt %, less than 18 wt %, less than 17 wt %, less than 16 wt %, or less than 15 wt %.

In some embodiments, the antistripping composition comprises from 10 wt % to 80 wt % of the first triamine compound comprising BHMT; from 10 wt % to 80 wt % of the second amine compound comprising an alkane triamine or an alkene triamine or a combination thereof, from 2 wt % to 20 wt % of the organic additive comprising ethanol, propanol, or an alkylene glycol, or corresponding esters of thereof, or combinations thereof, and less than 1 wt % of the nitrile compound.

In some cases, the antistripping composition comprises from 25 wt % to 75 wt % of the first triamine compound comprising BHMT; from 25 wt % to 75 wt % of a combination of second amine compounds, e.g., TAN and hexamethylene diamine; and less than 1 wt % of the nitrile compound.

### Additional Components

The antistripping composition may comprise (optional) additional components beyond the triamine component, nitrile component, and organic additive described above. In some cases, the antistripping composition preferable comprises relatively little of these additional components.

In some embodiments, the antistripping composition may comprise trace amounts of water. In one embodiment, for example, the antistripping composition comprises from 0 ppm to 100 ppm water, e.g., from 0 ppm to 80 ppm, from 0 ppm to 60 ppm, from 0 ppm to 40 ppm, from 0 ppm to 20 ppm, from 0.2 ppm to 100 ppm, from 0.2 ppm to 80 ppm, from 0.2 ppm to 60 ppm, from 0.2 ppm to 40 ppm, from 0.2 ppm to 20 ppm, from 0.4 ppm to 100 ppm, from 0.4 ppm to 80 ppm, from 0.4 ppm to 60 ppm, from 0.4 ppm to 40 ppm, from 0.4 ppm to 20 ppm, from 0.6 ppm to 100 ppm, from 0.6 ppm to 80 ppm, from 0.6 ppm to 60 ppm, from 0.6 ppm to 40 ppm, from 0.6 ppm to 20 ppm, from 0.8 ppm to 100 ppm, from 0.8 ppm to 80 ppm, from 0.8 ppm to 60 ppm, from 0.8 ppm to 40 ppm, from 0.8 ppm to 20 ppm, from 1 ppm to 100 ppm, from 1 ppm to 80 ppm, from 1 ppm to 60 ppm, from 1 ppm to 40 ppm, or from 1 ppm to 20 ppm. In terms of lower limits, the antistripping composition may comprise greater than 0 ppm water, e.g., greater than 0.2 ppm, greater than 0.4 ppm, greater than 0.6 ppm, greater than 0.8 ppm, or greater than 1 ppm. In terms of upper limits, the antistripping composition may comprise less than 100 ppm water, e.g., less than 80 ppm, less than 60 ppm, less than 40 ppm, or less than 20 ppm.

In some embodiments, the antistripping composition comprises substantially no water.

In some cases, the presence of a small amount of water has surprisingly been found to aid in performance, for example when the antistripping composition comprises mostly triamine component and little or no nitrile component. In some embodiments, the antistripping composition comprises water in an amount ranging from 0.01 wt % to 15 wt %, e.g., from 0.01 wt % to 10 wt %, from 0.1 wt % to 10 wt %, from 0.5 wt % to 10 wt %, from 1 wt % to 8 wt %, or from 3 wt % to 8 wt %. In terms of lower limits, the water may be present in the antistripping composition in an amount greater than 0.01 wt %, e.g., greater than 0.1 wt %, greater than 0.5 wt %, greater than 1 wt %, greater than 2 wt %, greater than 3 wt %, greater than 4 wt %, greater than 5 wt %, or greater than 6 wt %. In terms of upper limits, the water may be present in the antistripping composition in an amount less than 15 wt %, e.g., less than 10 wt %, less than 8 wt %, less than 5 wt %, less than 3 wt %, less than 1 wt %, less than 0.5 wt %, or less than 0.1 wt %.

### Characteristics of the Antistripping Composition

As detailed above, the antistripping composition of the present disclosure comprises components, e.g., the first triamine compound and the second amine compound, having amino, or nitrogen, moieties. The content of the amino moiety, particularly the amount of the active hydrogen, e.g., hydrogen bonded to a nitrogen atom), in the antistripping composition may be reported as an amine value. The amine value is reported as the mass (in milligrams) of potassium hydroxide (KOH) equal in basicity to one gram of the triamine composition.

In some embodiments, the antistripping composition of the present disclosure has an amine value of from 5 mg meq/g to 20 mg meq/g, e.g., from 5 mg meq/g to 18 mg meq/g, from 5 mg meq/g to 16 mg meq/g, from 5 mg meq/g to 14 mg meq/g, from 5 mg meq/g to 12 mg meq/g, from 6 mg meq/g to 20 mg meq/g, from 6 mg meq/g to 18 mg meq/g, from 6 mg meq/g to 16 mg meq/g, from 6 mg meq/g to 14 mg meq/g, from 6 mg meq/g to 12 mg meq/g, from 7 mg meq/g to 20 mg meq/g, from 7 mg meq/g to 18 mg meq/g, from 7 mg meq/g to 16 mg meq/g, from 7 mg meq/g to 14 mg meq/g, from 7 mg meq/g to 12 mg meq/g, from 8 mg meq/g to 20 mg meq/g, from 8 mg meq/g to 18 mg meq/g, from 8 mg meq/g to 16 mg meq/g, from 8 mg meq/g to 14 mg meq/g, from 8 mg meq/g to 12 mg meq/g, from 9 mg meq/g to 20 mg meq/g, from 9 mg meq/g to 18 mg meq/g, from 9 mg meq/g to 16 mg meq/g, from 9 mg meq/g to 14 mg meq/g, or from 9 mg meq/g to 12 mg meq/g. In terms of lower limits, the antistripping composition may have an amine value greater than 5 mg meq/g, e.g., greater than 6 mg meq/g, greater than 7 mg meq/g, greater than 8 mg meq/g, or greater than 9 mg meq/g. In terms of upper limits, the antistripping composition may have an amine value less than 20 mg meq/g, less than 18 mg meq/g, less than 16 mg meq/g, less than 14 mg meq/g, or less than 12 mg meq/g.

In some embodiments, the antistripping composition is a solution of the above-discussed components. Said another way, in some embodiments, the components of the antistripping composition form a substantially stable solution, e.g., at or below room temperature (from about 20° C. to 25° C.). In some cases, the antistripping composition is soluble for over 3 hours, for over 5 hours, for over 7 hours, for over 10 hours, for over 12 hours, or for over 14 hours. In some embodiment, the antistripping composition is soluble indefinitely.

In some embodiments, the antistripping composition is in a liquid state. In particular, in some embodiments, the antistripping composition is a liquid at or below room temperature (from about 20° C. to 25° C.).

### Bitumen Composition

In addition to the antistripping composition itself, the present disclosure provides bitumen compositions comprising the antistripping composition. In particular, the present disclosure provides bitumen compositions comprising a bituminous material, e.g., asphalt, and the antistripping composition detailed above. The presence of the antistripping composition in the bitumen compositions described herein beneficially reduce the susceptibility of the bitumen compositions (and the paved and/or compacted surfaces produced therefrom) to moisture and stripping.

The bitumen compositions of the present disclosure comprise a bituminous material. The compositions of the bituminous material is not particularly limited and may vary widely. The bituminous material may comprise any thermoplastic, naturally occurring or pyrolytically obtained substance comprised almost entirely of carbon and hydrogen and optionally comprising nitrogen, sulfur, and oxygen. As used herein, the term bituminous material is intended to include heavy oils, tars, crude residuum, pitch, asphalts, asphaltites, e.g., gilsonite, and asphaltenes.

In some embodiments, the bituminous material comprises an asphalt, e.g., an asphalt binder. As used herein, asphalt refers to any of the varieties of naturally-occurring and petroleum-derived bitumens of varying molecular weights from about 400 to above 5000, and composed of hydrocarbons and heterocyclics containing nitrogen, sulfur, and oxygen. The asphalt typically comprises naphthene aromatics, e.g., naphthalene, polar aromatics, e.g., high molecular weight phenols and carboxylic acids, saturated hydrocarbons, and/or asphaltenes, e.g., high molecular weight phenols and heterocyclic compounds.

The bituminous material, e.g., asphalt, may comprise or otherwise be suitable for use in hot-mix asphalt concrete (HMA), warm-mix asphalt concrete (WMA), and/or cold-mix asphalt concrete, e.g., cut-back asphalt concrete.

In embodiments wherein the bituminous material comprises asphalt, the viscosity grading of the asphalt is not particular limited. In some cases, the asphalt is has a grading of AC-2.5, AC-5, AC-10, AC-20, AC-30, AC-40, AR-10, AR-20, AR-40, AR-80, and/or AR-160, as measured according to AASTHO M 226.

In some embodiments wherein the bituminous material comprises asphalt, the asphalt may comprise a performance grade (PG) asphalt. Performance grading of asphalts is typically reported using two numbers: a first number giving the average seven-day maximum pavement temperature (in ° C.) (referred to herein as the “high-grade temperature”), and the second number giving the minimum pavement design temperature likely to be experience (in ° C.) (referred to herein as the “low-grade temperature”). In some embodiments, the bituminous material comprises a PG asphalt having a high-grade temperature from 50° C. to 80° C., e.g., from 55° C. to 75° C. or from 60° C. to 70° C., and a low-grade temperature from −10° C. to −40° C., e.g., from −15° C. to −35° C. or from −20° C. to −30° C.

As noted, the bitumen composition comprises an antistripping composition according to the present disclosure. The content of the antistripping composition in the bitumen composition is not particularly limited. In some embodiments, the bitumen composition comprises from 0.05 wt % to 5 wt % of the antistripping composition, e.g., from 0.05 wt % to 1.75 wt %, from 0.1 wt % to 5 wt %, from 0.05 wt % to 3 wt %, from 0.05 wt % to 2 wt %, from 0.05 wt % to 1.5 wt %, from 0.05 wt % to 1.25 wt %, from 0.05 wt % to 1 wt %, from 0.05 wt % to 0.75 wt %, from 0.1 wt % to 2 wt %, from 0.1 wt % to 1.75 wt %, from 0.1 wt % to 1.5 wt %, from 0.1 wt % to 1.25 wt %, from 0.1 wt % to 1 wt %, from 0.1 wt % to 0.75 wt %, from 0.15 wt % to 2 wt %, from 0.15 wt % to 1.75 wt %, from 0.15 wt % to 1.5 wt %, from 0.15 wt % to 1.25 wt %, from 0.15 wt % to 1 wt %, from 0.15 wt % to 0.75 wt %, from 0.2 wt % to 2 wt %, from 0.2 wt % to 1.75 wt %, from 0.2 wt % to 1.5 wt %, from 0.2 wt % to 1.25 wt %, from 0.2 wt % to 1 wt %, from 0.2 wt % to 0.75 wt %, from 0.25 wt % to 2 wt %, from 0.25 wt % to 1.75 wt %, from 0.25 wt % to 1.5 wt %, from 0.25 wt % to 1.25 wt %, from 0.25 wt % to 1 wt %, or from 0.25 wt % to 0.75 wt %. In terms of lower limits, the bitumen composition may comprise greater than 0.05 wt % of the antistripping composition, e.g., greater than 0.1 wt %, greater than 0.15 wt %, greater than 0.2 wt %, or greater than 0.25 wt %. In terms of upper limits, the bitumen composition may comprise less than 2 wt % of the antistripping composition, e.g., less than 1.75 wt %, less than 1.5 wt %, less than 1.25 wt %, less than 1 wt %, or less than 0.75 wt %.

In some embodiments, the disclosure relates to a process for improving durability in the aforementioned bitumen composition. The process comprises the step of adding the antistripping composition to the bitumen composition to form a treated bitumen composition. The treated bitumen composition may demonstrate the performance features described herein. In some embodiments, the antistripping composition is added in the amounts provided above. In some embodiments, the antistripping composition is added in an amount ranging from 0.05 wt % to 20 wt %, e.g., from 0.1 wt % to 20 wt %, e.g., from 0.1 wt % to 10 wt %, from 0.1 wt % to 5 wt %, from 0.1 wt % to 1 wt %, from 0.1 wt % to 2 wt %, or from 0.2 wt % to 4 wt %. In terms of lower limits, the antistripping composition may be added in an amount greater than 0.1 wt %, e.g., greater than 0.2 wt %, greater than 0.3 wt %, greater than 0.5 wt %, greater than 0.8 wt %, greater than 1.0 wt %, greater than 1.5 wt %, greater than 2.0 wt %, greater than 2.5 wt %, greater than 3.0 wt %, or greater than 5 wt %. In terms of upper limits, the antistripping composition may be added in an amount less than 20 wt %, e.g., less than 15 wt %, less than 10 wt %, less than 8 wt %, less than 5 wt %, less than 3 wt %, or less than 1 wt %. 0.05 wt % to 2 wt %.

### Characteristics of the Bitumen Composition

The bitumen compositions described herein advantageously demonstrate reduced susceptibility to moisture damage and stripping. In particular, the inclusion of the antistripping composition in the bitumen composition improves the performance characteristics, e.g., moisture resistance, of the overall bitumen compositions and of the paved and/or compacted surfaces produced therefrom.

As noted above, numerous test procedures assess the moisture susceptibility of a bitumen composition (such as asphalt concrete). In the boiling water test, defined by ASTM D 3625 (2020), a loose, e.g., non-paved and non-compacted, sample of bitumen composition, e.g., asphalt concrete, is added to boiling water and the percentage of total visible area of aggregate surface that retains its bond to the bituminous binder, e.g., asphalt, coating is measured. Although the boiling water test may be subject, it provides a simple and fast determination of the susceptibility of a bitumen composition to stripping.

In some embodiments, the bitumen composition of the present disclosure exhibits at least 50% coating retention, when measured according to ASTM D 3625 (2020), e.g., at least 52%, at least 55%, at least 58%, at least 60%, at least 62%, at least 65%, at least 68%, at least 70%, at least 72% or at least 75%. In terms of upper limits, the bitumen composition may exhibit a coating retention less than 100%, e.g., less than 98%, less than 95%, less than 92%, or less than 90%. In terms of ranges the bitumen composition may exhibit a coating retention from 50% to 100%, e.g., from 50% to 98%, from 55% to 98%, from 50% to 92%, from 50% to 90%, from 60% to 98%, from 60% to 95%, from 60% to 92%, from 60% to 90%, 65% to 100%, from 65% to 98%, from 65% to 95%, from 65% to 92%, from 65% to 90%, 68% to 100%, from 68% to 98%, from 68% to 95%, from 68% to 92%, from 68% to 90%, 70% to 100%, from 70% to 98%, from 70% to 95%, from 70% to 92%, from 70% to 90%, 72% to 100%, from 72% to 98%, from 72% to 95%, from 72% to 92%, from 72% to 90%, 75% to 100%, from 75% to 98%, from 75% to 95%, from 75% to 92%, or from 75% to 90%.

In the modified Lottman test, defined by AASHTO T 283 (2022), the tensile strength of unconditioned samples of a bitumen composition (such as asphalt concrete) are compared to the tensile strength of samples that have been partially saturated with water. The results are reported as the ratio of the dry tensile strength to the water conditioned (wet) tensile strength. Although it is typically expected that the water conditioned samples will have a lower tensile strength, lower values indicate greater susceptibility of the bitumen composition to moisture damage.

In some embodiments, the bitumen composition of the present disclosure exhibits a tensile strength ratio greater than 80, when measured according to AASHTO T 283 (2022), e.g., greater than 82, greater than 85, greater than 88, greater than 90, greater than 92, greater than 95, greater than 100, greater than 105, greater than 110, or greater than 115. In terms of upper limits, the bitumen composition may exhibit a tensile strength ratio less than 120, e.g., less than 115, less than 110, less than 105, less than 100, less than 99.5 or less than 99. In terms of ranges, the bitumen composition may exhibit a tensile strength ratio from 80 to 100, e.g., from 82 to 100, from 85 to 100, from 88 to 100, from 90 to 100, from 92 to 100, from 95 to 100, from 80 to 99.5, from 82 to 99.5, from 85 to 99.5, from 88 to 99.5, from 90 to 99.5, from 92 to 99.5, from 95 to 99.5, from 80 to 99, from 82 to 99, from 85 to 99, from 88 to 99, from 90 to 99, from 92 to 99, or from 95 to 99.

In the Hamburg wheel tracking test, defined by AASHTO T 324, bitumen compositions, e.g., asphalt concrete, are tested underwater to better understand moisture susceptibility. In this test, a loaded steel wheel tracks of a sample of the compacted bitumen composition in a heated water bath, and the deformation of the sample is observed.

In some embodiments, compacted samples of the bitumen compositions described herein exhibit a Hamburg wheel track testing rut depth of less than 10 mm, measured according to AASHTO T 324, e.g., less than 9 mm, less than 8 mm, less than 7 mm, less than 6 mm, or less than 5 mm. In terms of lower limits, the compacted samples of the bitumen composition may exhibit a Hamburg wheel track testing rut depth of greater than 1 mm, e.g., greater than 1.5 mm, greater than 2 mm, or greater than 2.5 mm. In terms of ranges, the compacted samples of the bitumen composition may exhibit a Hamburg wheel track testing rut depth of from 1 mm to 10 mm, e.g., from 1 mm to 9 mm, from 1 mm to 8 mm, from 1 mm to 7 mm, from 1 mm to 6 mm, from 1 mm to 5 mm, from 1.5 mm to 10 mm, from 1.5 mm to 9 mm, from 1.5 mm to 8 mm, from 1.5 mm to 7 mm, from 1.5 mm to 6 mm, from 1.5 mm to 5 mm, from 2 mm to 10 mm, from 2 mm to 9 mm, from 2 mm to 8 mm, from 2 mm to 7 mm, from 2 mm to 6 mm, from 2 mm to 5 mm, from 2.5 mm to 10 mm, from 2.5 mm to 9 mm, from 2.5 mm to 8 mm, from 2.5 mm to 7 mm, from 2.5 mm to 6 mm, or from 2.5 mm to 5 mm.

Additional test methods for assessing the moisture susceptibility of the bitumen composition and of the paved and/or compacted surfaces produced therefrom include the Tunnicliff and Root conditioning test (defined by ASTM D 4867), the static-immersion test (defined by AASHTO T 182), and the immersion-compression test (defined by AASHTO T 165).

### Carbonyl Index

In some embodiments, compacted samples of the bitumen compositions described herein exhibit a carbonyl index reduction greater than 0.1, as measured against a control and after 20 hours of aging (PAV₂₀) under ASTM D7214 (current year), e.g., greater than 0.15, greater than 0.2, greater than 0.25, greater than 0.3 greater than 1.0, greater than 5.0, greater than 10.0, greater than 13.0, or greater than 15.0.

In some embodiments, compacted samples of the bitumen compositions described herein exhibit a carbonyl index reduction greater than 0.1, as measured against a control and after 40 hours of aging (PAV₄₀) under ASTM D7214 (current year), e.g., greater than 0.15, greater than 0.2, greater than 0.25, greater than 0.3, greater than 0.35, or greater than 0.4.

In some embodiments, compacted samples of the bitumen compositions described herein exhibit a carbonyl index reduction greater than 0.1, as measured against a control and after 60 hours of aging (PAV₆₀) under ASTM D7214 (current year), e.g., greater than 0.15, greater than 0.2, greater than 0.25, greater than 0.3, greater than 0.35, greater than 0.4, greater than 0.5, greater than 0.6, or greater than 0.7.

### BBR Stiffness

In some embodiments, compacted samples of the bitumen compositions described herein exhibit a BBR Stiffness less than 222 MPa, as measured in accordance with AASHTO T313 (current year) and after 20 hours of aging (PAV₂₀), e.g., less than 220 MPa, less than 218 MPa, less than 216 MPa, less than 214 MPa, or less 212 MPa.

In some embodiments, compacted samples of the bitumen compositions described herein exhibit a BBR Stiffness less than 222 MPa, as measured in accordance with AASHTO T313 (current year) and after 40 hours of aging (PAV₄₀), e.g., less than 248 MPa, less than 247 MPa, less than 245 MPa, less than 242 MPa, less than 240 MPa, or less 239.

In some embodiments, compacted samples of the bitumen compositions described herein exhibit a BBR Stiffness less than 222 MPa, as measured in accordance with AASHTO T313 (current year) and after 60 hours of aging (PAV₆₀), e.g., less than 288 MPa, less than 285 MPa, less than 280 MPa, less than 275 MPa, or less 271.

### BBR M Value

In some embodiments, compacted samples of the bitumen compositions described herein exhibit a BBR M value greater than 0.341, as measured in accordance with AASHTO T313 (current year) and after 20 hours of aging (PAV₂₀), e.g., greater than 0.3415, greater than 0.342, greater than 0.3425, or greater than 0.343.

In some embodiments, compacted samples of the bitumen compositions described herein exhibit a BBR M value greater than 0.312, as measured in accordance with AASHTO T313 (current year) and after 40 hours of aging (PAV₄₀), e.g., greater than 0.3125, greater than 0.313, greater than 0.314, or greater than 0.315.

In some embodiments, compacted samples of the bitumen compositions described herein exhibit a BBR M value greater than 0.288, as measured in accordance with AASHTO T313 (current year) and after 60 hours of aging (PAV₆₀), e.g., greater than 0.290, greater than 0.292, greater than 0.294, greater than 0.295.

In some embodiments, any or some of the steps or components disclosed herein may be considered optional. In some cases, any or some of the aforementioned items in this description may expressly excluded, e.g., via claim language. For example claim language may be modified to recite that the composition does not comprise or excludes a particular amine, e.g., heptane diamine, or does not comprise or excludes castor oil.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

### Examples

The present disclosure will be further understood by reference to the following non-limiting examples.

Antistripping compositions described herein were prepared to assess their effectiveness in reducing the moisture susceptibility of a bitumen composition. BHM L-500, which comprises BHMT (first triamine compound) and Hexatran 300 (second amine compound) were used as amine components. BHM L-500 comprised ˜60 wt % BHMT and the reminder nitrogen-containing impurities that were not triamines/amines/nitriles disclosed herein. Hexatran 300 comprises TAN. The compositions of the sample antistripping compositions are reported in Table 1A. In some cases, amounts of nitrogen-containing compounds (other than BHMT and TAN) were present as well.

Six working examples of bitumen compositions (Exs. 1-6) and one comparative example (Comp. Ex. A) were prepared. Each sample was prepared using a performance grade bituminous material (asphalt) having a high-grade temperature of 64° C. and low-grade temperature of −22° C. (referred to as “PG 64-22”). Exs. 1-4 contain a single type of antistripping compound, either a first triamine (BHMT, e.g., BHM L-500) or a second amine (TAN, e.g., Hextran-300); Exs. 5 and 6 each contain a mixture of both BHM L-500 and Hextran-300, at a ratio of 1:1. The aforementioned antistripping compositions were added to the PG 64-22 in the amounts shown in Table 1. Comp. Ex. A comprises PG 64-22 and did not employ an antistripping composition.

TABLE 1
Exemplary Bitumen Compositions for Testing

| | Antistripping Comp. | | Bitumen | |
|---|---|---|---|---|
| Bitumen Comp. | Cpd. | wt. % | Cpd. | wt. % |
| Ex. 1 | BHM L-500 | 0.3 | PG 64-22 | 99.7 |
| Ex. 2 | BHM L-500 | 0.5 | PG 64-22 | 99.5 |
| Ex. 3 | Hexatran-300 | 0.3 | PG 64-22 | 99.7 |
| Ex. 4 | Hexatran-300 | 0.5 | PG 64-22 | 99.5 |
| Ex. 5 | BHM L-500:Hexatran- | 0.3 | PG 64-22 | 99.7 |
| | 300 = 1:1 | | | |
| Ex. 6 | BHM L-500:Hexatran- | 0.5 | PG 64-22 | 99.5 |
| | 300 = 1:1 | | | |
| Comparative | — | — | PG 64-22 | 100 |
| Ex. A | | | | |

The moisture susceptibility of the above exemplary bitumen compositions was assessed by numerous tests. For each bitumen composition, a boiling water test was carried out according to ASTM D 3625 (2020) to assess the adhesion of the asphalt binder. Results of this test are reported in Table 2. The performance of the Examples were ranked from 1 to 7, with 1 having the best performance (Ex. 4), and 7 having the poorest performance (Comp. Ex. A).

TABLE 2
Boiling Water Test (ASTM D 3625 (2020))

| | Observation | | |
|---|---|---|---|
| | Approx. retained | Approx. | |
| | coating (%) | un-coated (%) | Ranking |
| Ex. 1 | 50 | 50 | 6 |
| Ex. 2 | 70 | 30 | 4 |
| Ex. 3 | 65 | 35 | 5 |
| Ex. 4 | 85 | 15 | 1 |
| Ex. 5 | 75 | 25 | 2 (tie) |
| Ex. 6 | 75 | 25 | 2 (tie) |
| Comparative | 15 | 85 | 7 |
| Ex. A | | | |

The results of the boiling water test indicate that all six exemplary bitumen compositions, Exs. 1-6 exhibited good adhesion (at least 50% coating retained after the boiling test)—much better than Comp. Ex. A (only 15%). Exs. 2 and 4 with 0.5% antistripping composition each demonstrated superior performance—even better than Exs. 1 and 3, which performed well in their own right. Exs. 5 and 6, each with a mixture of both types of antistripping compositions, also showed superior performance—the retained coatings on both of these Examples were higher than most of the other Examples (Exs. 1-3), which have only one type of antistripping composition. Comparative Ex. A, which has no antistripping composition exhibited extreme de-bonding (stripping) in the presence of water (only about 15% coating retained after the boiling test). Each of the Exs. 1-6, which include antistripping compositions according to the present disclosure, exhibited much better adhesion than Comparative Ex. A (at least 35% more coating retained after the boiling water test).

Each bitumen composition was tested for Tensile Strength Ratio (TSR) according to AASHTO T 283 (2022) to assess the resistance of the bitumen compositions to moisture-induced damage. This is an industrial standard test to assess a pavement's sensitivity to water. Results of TSR are reported in Table 3.

TABLE 3
Tensile Strength Ratio (AASHTO T 283 (2022))

Tensile strength (psi)

| | Subset | Dry | Wet | Avg. TSR (%) |
|---|---|---|---|---|
| Ex. 1 | 1 | 155.1 | 153.8 | 99 |
| | 2 | 162.0 | 162.9 | |
| | 3 | 167.5 | 164.2 | |
| | Avg. | 161.5 | 160.3 | |
| Ex. 2 | 1 | 170.4 | 152.0 | 100 |
| | 2 | 167.6 | 173.6 | |
| | 3 | 165.5 | 179.6 | |
| | Avg. | 167.8 | 168.4 | |
| Ex. 3 | 1 | 175.0 | 166.5 | 106 |
| | 2 | 158.6 | 180.3 | |
| | 3 | 166.2 | 184.4 | |
| | Avg. | 166.6 | 177.1 | |
| Ex. 4 | 1 | 160.1 | 167.4 | 101 |
| | 2 | 169.2 | 173.1 | |
| | 3 | 170.0 | 175.4 | |
| | Avg. | 166.4 | 168.6 | |
| Comp. | 1 | 168.9 | 106.0 | 72 |
| Ex. A | 2 | 144.9 | 129.5 | |
| | 3 | 179.7 | 122.0 | |
| | Avg. | 164.5 | 119.2 | |

The results of the TSR test indicate that all four exemplary bitumen compositions exhibited good resistance to moisture-induced damage. As shown above, each of Exs. 1-4 demonstrated similar average degree of saturation but, advantageously, much higher tensile strength ratios than that of Comparative Ex. A. Comparative Ex. A exhibited extreme susceptibility to moisture-induced damage. Each of Exs. 1-4 included antistripping compositions according to the present disclosure and exhibited much better adhesion than Comparative Ex. A. The TSR of any one of the Exs. 1-4 was at least 2700 higher than that of Comparative Ex. A. The results indicated both amines (BHM L-500 and Hexatran-300) at the 0.30% and 0.50% dosages easily exceeded the minimum industry standard TSR value of 80% and were extremely effective. The differences between the TSRs, from 99% to 106% is within the acceptable variance range of the test. Due to testing variances, 106% can be interpreted as 100%.

In addition, the examples demonstrate that the antistripping compositions surprisingly provide for improvements in tensile strength after conditioning (see “Wet” values in Table 3). Comp. Ex. A demonstrated wet tensile strength ranging from 106 to 130 psi, while the working examples unexpectedly demonstrated much higher values—154 to 184 psi. The average tensile strength of the examples in the unconditioned sets was 165.6 psi, and the average conditioned strength was 168.6 psi. The Hexatran-300 at 0.3% had the highest increase when compared to the Comparative Ex. A with a 48.6% increase in tensile strength.

Additionally, Exs. 5 and 6, each with a mixture of both types of antistripping compositions, also exceeded the minimum industry standard value of 80%—wherein Ex. 5 has a TSR of 86 and Ex 6 has a TSR of 91. Despite these TSRs are lower than Exs. 1-4, which contain only one type of antistripping composition, Exs. 5 and 6 still show superior performance than Comparative Ex. A that has no antistripping composition.

### Embodiments

As used below, any reference to a series of embodiments is to be understood as a reference to each of those embodiments disjunctively, e.g., “Embodiments 1-4” is to be understood as “Embodiments 1, 2, 3, or 4”).

Embodiment 1: an antistripping composition, comprising a first triamine compound or a second amine compound, and less than 1 wt %, preferably less than 0.1 wt % of a nitrile compound, preferably tricyanohexane.

Embodiment 2: an antistripping composition of embodiment 1, wherein the first triamine compound comprises di(4-amino-butyl)amine, di(5-amino-pentyl)amine, di(6-amino-hexyl)amine, e.g., bis(hexamethylene(triamine)), di(7-amino-heptyl)amine, di(8-amino-octyl)amine, (4-amino-butyl)(5-amino-pentyl)amine, (4-amino-butyl)(6-amino-hexyl)amine, bis(hexamethylene)triamine (BHMT), (4-amino-butyl)(7-amino-heptyl)amine, (4-amino-butyl)(8-amino-octyl)amine, (5-amino-pentyl)(6-amino-hexyl)amine, (5-amino-pentyl)(7-amino-heptyl)amine, or (5-amino-pentyl)(8-amino-octyl)amine, or combinations thereof.

Embodiment 3: an antistripping composition of embodiment 1 and/or 2, wherein the first triamine compound has the chemical structure:

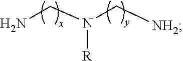

wherein x and y are independently from 1 to 10, and wherein R is hydrogen, a C₁-C₅ alkyl group, a C₂-C₅ alkenyl group, or a C₁-C₅ alcohol group.

Embodiment 4: an antistripping composition of embodiments 1-3, wherein the first triamine compound comprises BHMT.

Embodiment 5: an antistripping composition of embodiments 1-4, wherein the second amine compound comprises an alkane amine or an alkene amine.

Embodiment 6: an antistripping composition of embodiments 1-5, wherein the second amine compound comprises triaminononane.

Embodiment 7: an antistripping composition of embodiments 1-6, wherein the second amine compound has the structure:

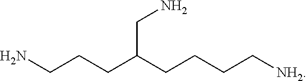 [SMILES: NCCCCC(CN)CCCN]

Embodiment 8: an antistripping composition of embodiments 1-7, comprising less than 0.1 wt % nitrile compound.

Embodiment 9: an antistripping composition of embodiments 1-8, comprising less than 1 wt % tricyanohexane.

Embodiment 10: an antistripping composition of embodiments 1-9, wherein the first triamine is present in an amount ranging from 10 wt % to 80 wt %; and the second amine is present resent in an amount ranging from 10 wt % to 80 wt.

Embodiment 11: an antistripping composition of embodiments 1-10, further comprising an organic additive.

Embodiment 12: an antistripping composition of embodiments 1-11, wherein the organic additive comprises a vegetable oil comprising canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, or linseed oil, or combinations thereof.

Embodiment 13: an antistripping composition of embodiments 1-12, wherein the organic additive comprises an ester having a chemical structure:

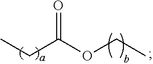

wherein a and b are independently from 0 to 4.

Embodiment 14: an antistripping composition of embodiments 1-13, wherein the organic additive comprises ethanol, propanol, or an alkylene glycol, or corresponding esters of thereof, or combinations thereof.

Embodiment 15: an antistripping composition, comprising an amine compound comprising an alkane triamine or an alkene triamine or a combination thereof; and less than 1 wt % of a nitrile compound.

Embodiment 16: an antistripping composition, comprising from 10 wt % to 80 wt % of a first triamine compound comprising BHMT; from 10 wt % to 80 wt % of a second amine compound comprising an alkane triamine or an alkene triamine or a combination thereof, from 2 wt % to 20 wt % of an organic additive comprising ethanol, propanol, or an alkylene glycol, or corresponding esters of thereof, or combinations thereof; and less than 1 wt % of a nitrile compound.

Embodiment 17, a bitumen composition, comprising a bituminous material; and the antistripping composition of claims 1-15.

Embodiment 18: an antistripping composition of embodiment 16, wherein the bitumen composition comprises from 0.1 wt % to 5 wt % of the antistripping composition.

Embodiment 19: an antistripping composition of embodiment 17 and/or 18, wherein the bitumen composition exhibits at least 50% coating retention, measured according to ASTM D 3625 (2020) and/or a tensile strength ratio greater than 80, measured according to AASHTO T 283 (2022).

Embodiment 20: a process for improving durability in a bitumen composition comprising a bituminous material, the process comprising adding the antistripping composition of claims 1-15 to the bitumen composition to form a treated bitumen composition, wherein, upon aging for 40 days, the treated bitumen composition demonstrates a BBR stiffness less than 247 MPa, as measured in accordance with AASHTO T313 (2022).

We claim:

1. An antistripping composition, comprising:
a first triamine compound or a second amine compound; and
less than 1 wt % of a nitrile compound;
wherein, when used in a bitumen composition, the bitumen composition demonstrates 50% or more retained coating, measured according to AASHTO T 283 (2022); and
a tensile strength ratio (TSR) of at least 80%, measured according to ASTM D 3625 (2020).

2. The antistripping composition of claim 1, wherein the first triamine compound comprises di(4-amino-butyl)amine, di(5-amino-pentyl)amine, di(6-amino-hexyl)amine, e.g., bis(hexamethylene(triamine)), di(7-amino-heptyl)amine, di(8-amino-octyl)amine, (4-amino-butyl)(5-amino-pentyl)amine, (4-amino-butyl)(6-amino-hexyl)amine, bis(hexamethylene)triamine (BHMT), (4-amino-butyl)(7-amino-heptyl)amine, (4-amino-butyl)(8-amino-octyl)amine, (5-amino-pentyl)(6-amino-hexyl)amine, (5-amino-pentyl)(7-amino-heptyl)amine, or (5-amino-pentyl)(8-amino-octyl)amine, or combinations thereof.

3. The antistripping composition of claim 1, wherein the first triamine compound has the chemical structure: 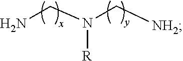
wherein x and y are independently from 1 to 10, and wherein R is hydrogen, a C₁-C₅ alkyl group, a C₂-C₅ alkenyl group, or a C₁-C₅ alcohol group.

4. The antistripping composition of claim 1, wherein the first triamine compound comprises BHMT.

5. An antistripping composition, comprising:
an amine compound comprising an alkane triamine or an alkene triamine or a combination thereof, and
less than 1 wt % of a nitrile compound;
wherein, when used in a bitumen composition, the bitumen composition demonstrates 50% or more retained coating, measured according to AASHTO T 283 (2022); and
a tensile strength ratio (TSR) of at least 80%, measured according to ASTM D 3625 (2020).

6. The antistripping composition of claim 1, wherein the second amine compound comprises an alkane amine or an alkene amine.

7. The antistripping composition of claim 1, wherein the second amine compound comprises triaminononane.

8. The antistripping composition of claim 1, wherein the second amine compound has the structure:

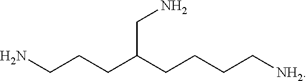 [SMILES: NCCCCC(CN)CCCN]

9. The antistripping composition of claim 1, comprising less than 0.1 wt % nitrile compound.

10. The antistripping composition of claim 1, comprising less than 1 wt % tricyanohexane.

11. The antistripping composition of claim 1, wherein the first triamine is present in an amount ranging from 10 wt % to 80 wt %; and the second amine is present resent in an amount ranging from 10 wt % to 80 wt %.

12. The antistripping composition of claim 1, further comprising an organic additive.

13. The antistripping composition of claim 12, wherein the organic additive comprises a vegetable oil comprising canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, or linseed oil, or combinations thereof.

14. The antistripping composition of claim 12, wherein the organic additive comprises an ester having a chemical structure: 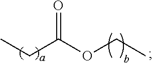
wherein a and b are independently from 0 to 4.

15. The antistripping composition of claim 12, wherein the organic additive comprises ethanol, propanol, or an alkylene glycol, or corresponding esters of thereof, or combinations thereof.

16. An antistripping composition, comprising:
from 10 wt % to 80 wt % of a first triamine compound comprising BHMT;
from 10 wt % to 80 wt % of a second amine compound comprising an alkane triamine or an alkene triamine or a combination thereof;
from 2 wt % to 20 wt % of an organic additive comprising ethanol, propanol, or an alkylene glycol, or corresponding esters of thereof, or combinations thereof, and
less than 1 wt % of a nitrile compound.

17. A bitumen composition, comprising:
a bituminous material; and
the antistripping composition of claim 1;
wherein the bitumen composition demonstrates 50% or more retained coating as measured via AASHTO T 283 (2022); and
a tensile strength ratio (TSR) of at least 80%, measured according to ASTM D 3625 (2020).

18. The bitumen composition of claim 17, wherein the bitumen composition comprises from 0.1 wt % to 5 wt % of the antistripping composition.

19. A process for improving durability in a bitumen composition comprising a bituminous material, the process comprising:
adding the antistripping composition of claim 1 to the bitumen composition to form a treated bitumen composition,
wherein, upon aging for 40 days, the treated bitumen composition demonstrates a BBR stiffness less than 247 MPa, as measured in accordance with AASHTO T 313 (2022).

20. An antistripping composition, comprising:
a first triamine compound comprises BHMT or a second amine compound comprises triaminononane; and
less than 1 wt % of a nitrile compound;
wherein, when the antistripping composition is used in a bitumen composition from 0.1 wt % to 5 wt %, the bitumen composition demonstrates 50% or more retained coating, measured according to AASHTO T 283 (2022); and
a tensile strength ratio (TSR) of at least 80%, measured according to ASTM D 3625 (2020).
